(19) United States
(12) Patent Application Publication
(10) Pub. No.: US 2025/0360746 A1
(43) Pub. Date: Nov. 27, 2025

(54) Layered Structure and Method For Producing 3D Cards

(71) Applicant: Sejer Sejersen, San Diego, CA (US)

(72) Inventor: Sejer Sejersen, San Diego, CA (US)

(21) Appl. No.: 19/218,148

(22) Filed: May 23, 2025

Related U.S. Application Data
(60) Provisional application No. 63/651,159, filed on May 23, 2024.

(51) Int. Cl. B42D 25/20; B42D 25/45

(52) U.S. Cl. CPC B42D 25/20; B42D 25/45

(57) ABSTRACT

The present invention is a layered structure and method for the printing of 3D cards through the application of ultra violet curable material. While this method is particularly useful in the printing of sports and trading cards, it could be used for other types of cards that includes both business and playing cards. There are potentially five different layers, or more depending on the desired effect, that will be printed atop a base substrate. The 3D effects will be due to the print settings for two different layers of clear UV ink. The first layer of UV ink will provide the majority of thickness to ensure the image or text for a card protrudes from the surface, while the second layer of UV ink will be applied so that a textured appearance is given to the card.

### RELATED APPLICATIONS

This application claims priority to U.S. Provisional Patent Application No. 63/651,159 entitled “Layered Structure and Method for Producing 3D Cards” filed May 23, 2024, and currently co-pending, the entirety of which is incorporated herein by reference.

### FIELD OF THE INVENTION

The present invention relates to UV printing to create three-dimensional cards such as sports, business, and game cards.

### BACKGROUND OF THE INVENTION

Sports cards have been a feature of American society since the time professional organized sports started. The first set of baseball cards that were made available to the public trace their origins back to the late 1800s and early 1900s when cigarette companies included the sports cards inside of their products. While, the earliest sports cards were for baseball players, their popularity spread to other major sports leagues as the leagues formed.

Currently, sports cards are printed onto two dimensional pieces of cardstock. These cards currently only feature the player, the team, and sometimes statistics about the player. While there are some limited-edition cards occasionally released, there is typically not an interactive aspect to them. One way to improve the interactivity of sports cards would be to print 3D versions of publicly available cards, but currently there is no reliable way to do so.

Different material would have to be used if 3D sports cards were to be printed. While ideal for 2D prints, cardstock is not strong enough to hold up to the additional weight that a 3D card would have, and any flexibility would result in significant cracking and ultimately cause the failure of the card itself. Compounding the issue is that depending on the more rigid material selected, the costs associated with producing 3D sports cards rise significantly.

Thus, there is a need in the art for a method to produce a 3D sports trading card that is durable and cost effective to make.

### SUMMARY OF THE INVENTION

The present invention is a layered structure and method that meets the above need in the art by creating a new and novel way to print 3D sports cards through ultraviolet (“UV”) curable printing. While this structure and method is directed towards the printing of 3D sports card, the same can easily be adapted for use in the production of other cards such as game cards, trading cards, and business cards.

UV printing is a subtype of direct-to-object printing that allows 2D images to be printed onto a 3D surface. What is unique about UV printing is that it employs the use of UV printing ink that is cured as the printing process occurs. To ensure a stable print surface, a UV printer is typically fitted with specifically designed tooling to hold an object in place while the print process occurs.

The novel method disclosed here is a method of using UV printing technology to produce 3D printed cards. While the disclosed embodiment throughout this specification are sport cards, this new methodology can be used for a wide variety of different cards. These different types of cards include business cards, trading cards, and playing cards.

Starting with a rigid substrate, a first layer is a clear primer that is applied onto the substrate. This allows for the subsequent layers to successfully bond to the substrate, but does not hide, mark, or cover up the substrate material. A second layer is clear UV ink that is printed directly onto the clear primer. What is important about this second layer is that it can be printed at variable thicknesses depending on how much the image or text need to protrude from the surface of the substrate. This provides the requisite height so that the printed images or text are elevated from the surface of the rigid substrate.

A third layer is a second clear UV ink that is printed with variable thickness, like the second layer, but the purpose of this third layer is to provide texturing effects depending on the needs of the printing job. A fourth layer is a white ink that is printed on top of the third layer so that the colors of the fifth layer, which is a typical 4 color process, appear without a glossy effect.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIGS. 1A-1D illustrate the different stages of the printing process involved with the present invention;

FIG. 2 is an enlarged side view of a 3D sports card after completing all four steps involved;

FIGS. 3A and 3B are section views of only the first layer of UV ink to show the different thicknesses that can be achieved by following the printing process of the present invention;

FIG. 4 is a section view of only the second layer of UV ink to show the different textures that can be achieved by following the printing process of the present invention;

FIG. 5A-5E illustrates the different stages of an alternative printing process involved with the present invention; and

FIG. 6 is a section view of only the second layer of UV ink to show the different textures that can be achieved by following the printing process of the present invention.

### DETAILED DESCRIPTION OF THE INVENTION

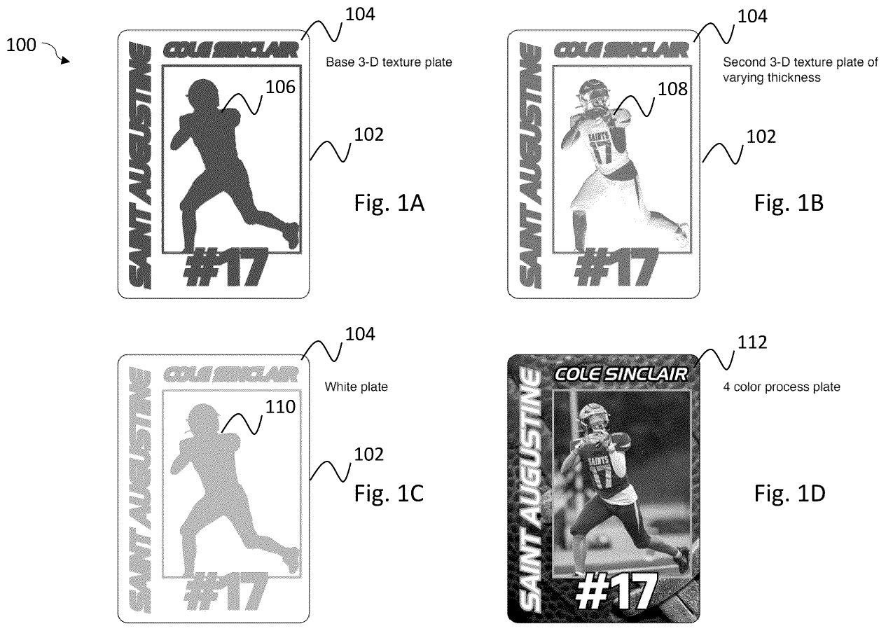

Referring initially to FIGS. 1A-1D, a step-by-step top view of the different key layers for the present invention are shown. In this embodiment base substrate 102 is made out of aluminum. However, any other rigid substrate that is known in the art, such as carbon fiber or wood, is fully envisioned as suitable substitutes.

Specific to FIG. 1A, a card 100 is shown with the first two layers already printed on top of base substrate 102. The first layer is clear primer 104 that is used to improve the adhesive properties, if needed, for base substrate 102. In a preferred embodiment where base substrate 102 is aluminum, clear primer 104 is needed to improve the adhesion for the next layer because of the low surface tension of aluminum. In other embodiments, where a different material is used for base substrate 102, more or less clear primer may be needed depending on the surface tension properties of the substitute material. It is fully envisioned that other materials that could be used for base substrate 102 include wood, other metals, and any other known material commonly known in the art.

Once the first layer of clear primer 104 is applied to base substrate 102, a second layer of clear UV ink 106 is printed on top of it. Clear UV ink 106 is printed so that it provides a specific thickness to either an image or text that is included in the print; thus, providing the majority of the thickness for the portion of card 100 that is intended to have a 3-dimensional appearance.

Specific to FIG. 1B, a third layer printed onto card 100 is now shown. This third layer is a second layer of clear UV ink 108; however, this layer is printed at a variable thickness across a given print line to provide the requisite textures for any given image.

Specific to FIG. 1C, a fourth layer is printed onto card 100. This fourth layer is a layer of white ink 110 that is printed onto the second layer to cover up base substrate 102 where needed. This ensures that the subsequent layer of color printing, shown in FIG. 1D, covers up base substrate 102 so that it does not show through after completion of the entire process; resulting in a more accurate appearance of the printed image. Additionally, this layer, depending on print settings, can ensure that the resulting image does not have a glossy appearance and a more striking color appearance is given to card 100. While this fourth layer of white ink 110 is shown in this embodiment, it is fully envisioned that this layer can be optional should a user want the color ink of the fifth layer to have a glossy finish, or show the surface of base substrate 102.

FIG. 1D is the final layer of the method disclosed here, and it involves printing color layer 112. The technique used to print color layer 112 is the well-known four-color process technique which involves the use of cyan, magenta, yellow, and black (CMYK) to produce any given color a particular print job may need.

In this embodiment, FIGS. 1A-1D show that card 100 is a sports card, however, other types of cards such as a business cards are fully envisioned. Further, due to the universality of this new method, different templates can be created depending on the intended use. For example, the sports card shown in FIG. 1D is a template that can have different players and text swapped out to change the appearance of the cards. In alternative embodiments, card 100 is a business card, where the front lists traditional business information, but the back has an ornamental design to improve the visual appearance of the card.

Prior to starting the newly disclosed method, a user will first have to adjust various print settings by editing the image to be printed within a photo editing software. When the photo or image is first uploaded into the software, it is crucial to check that the image is ready for CMYK (cyan, magenta, yellow, and black) printing. The reason for this is that CMYK printing can have an impact on how a certain color is displayed, so a user may have to adjust the color settings within the software to ensure that the desired colors are printed correctly onto card 100.

Next, a user will need to set up a couple of different layers that are responsible for the raised and textured appearance of card 100. For the raised appearance, a separate layer will need to be created by the user within the software. This is typically achieved by copying the CMYK file and then converting the image to either grey scale or black and white. Once that is completed, then the greyscale or black and white settings can be adjusted so that the darkness of the image matches the desired thickness. In most readily available UV printers, a certain greyscale level corresponds with a thickness of ink to be printed. Once that is complete the user can adjust the detail and darkness setting of the filter until a desired texture is achieved. Similar to what was disclosed for the thickness settings, most UV printers use the adjusted detail and darkness setting to print the desired textured effects.

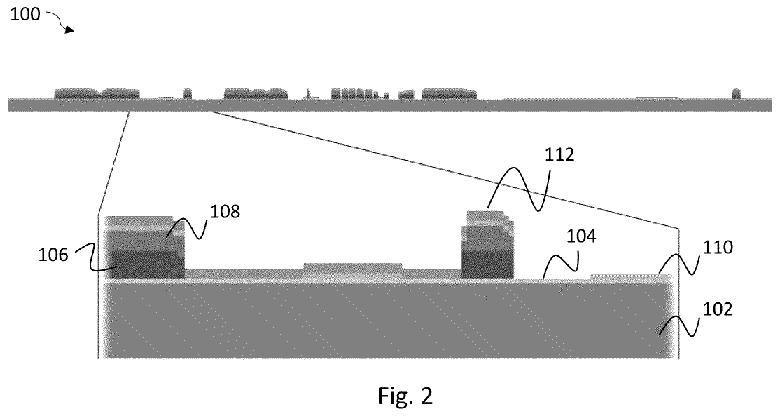

Referring now to FIG. 2, a cross-section view of card 100 with the five layers printed atop base substrate 102 is shown. The following steps illustrate the preferred application of the new method disclosed.

First, a layer of clear primer 104 is applied directly onto the surface of base substrate 102. This layer can either be sprayed directly onto the surface, applied with a Mayer bar coater, or manually applied. As mentioned earlier, clear primer 104 is added to base substrate 102 primarily to serve as a preparatory coat to the surface of base substrate 102. Clear primer 104 is able to successfully bind to the surface of base substrate 102 and simultaneously allows for the adhesion of subsequent layers of UV ink to adhere to card 100.

It is important to note that after clear primer 104 is applied to base substrate 102, the UV printer ink jets for the following steps will be set to a predetermined height above base substrate 102. This predetermined height will be set to the highest level needed so that the thickest portion of the card, once all five layers are printed, can fit inside the printer and ensure excellent print quality. Further, the UV printer ink jets will print unidirectionally instead of bidirectionally to ensure the best print quality possible. If bidirectional printing was used, then an undesirable card 100 would result because the colors would appear blurry and misregistered due to timing issues with ink firing because of the varying distance from the print heads to any variable thickness previously printed layers.

The second step involves printing a coating of UV ink 106. This first coating of UV ink serves to provide the requisite thickness needed to ensure that any given image or text for card 100 protrudes from the surface of base substrate 102. Specific to the first layer of UV ink 106, in some cases up to seven layers can be printed on a single pass that provides a tremendous amount of flexibility for the final thickness of card 100. However, it is fully envisioned that in other embodiments of the process more than seven layers can be printed when a UV printer with a higher height tolerance is used. As mentioned earlier, the requisite thickness will be determined by the user prior to beginning the print process.

The third step involves printing a layer of UV ink 108. In contrast to the second layer, which provided majority of the needed thickness for a given print, the third layer of UV ink 108 is used to provide the needed texture. This is achieved by allowing the UV ink jet printers to distribute a varied amount of ink across an individual print line. This varied distribution of UV ink 108 translates to a varied height throughout a given print line. Therefore, once this third step is completed, a textured effect that is dependent on the user settings entered into the photo editing software will be displayed.

The fourth step involves the printing a layer of white ink 110 onto the UV ink 108. The printer used in the process will be able to adjust to the varied thickness of UV ink 108 to ensure a smooth print of white ink 110 is performed. Further, the purpose of this layer of white ink 110 is to ensure that base substrate 102 does not show through the final print, and that card 100 does not have a glossy appearance. This layer can also be entirely optional depending on the different print settings of a user, or white ink 108 can be printed onto only certain areas of card 100. There will be some instances where the image of card 100 will need a metallic finish in some areas of a card, so white ink 108 will not be printed there, while there are other areas where card 100 will need a layer of white ink 108 for solid color appearance.

Further, the layer of white 110 is programmed to only print within the borders of an image or text, and is not programmed to the same size specifications as the first two layers of UV ink. The discrepancy in size is intentional because if white ink 110 was given the same dimensions as the prior two layers, then faint traces of white ink 110 would be visible once the final layer of color ink is applied to card 100; which is an undesirable visual result for most embodiments of card 100. The smaller size of the print area for white ink 110 ensures a higher quality print image at the end of the process.

The final step involves the printing of color ink 112 directly onto white ink layer 110, as well as areas without white or texture. Color ink 112 is a typical four-color process that is used throughout the industry. The colors used in the four-color process are cyan, magenta, yellow, and black. This allows a user to print any specific color that may be needed for any given print job.

A uniqueness of the present invention and related method is the creation of a three-dimensional and textured surface having a desired textured image using print technologies, including multi-pass printing using UV curable epoxies to create a raised image. Once the raised image is in place, the desired color or transparent or opaque layers are printed over the top of the textured surface to create the unique three-dimensional image. The three-dimensional surface, or image model, is hidden behind the printing and invisible to the viewer of the surface.

In contrast to typical embossing techniques which include an imprint on the backside of a substrate to create a raised image, the present invention allows two-sided printing of a three-dimensional image as there is no imprint to overcome in order to create a raised image on the backside of a substrate; a three-dimensional image may be printed on both the front and the back of the substrate.

It is important to note that the prior described process is just one of several different processes that could take advantage of this new printing technique.

In a non-limiting example, the final step of printing the four-color process ink can occur first and print the color ink directly onto base substrate 102 first. Then first layer of UV ink 106 and second layer of UV ink 108 could be the subsequent layers. The two different layers of UV ink will still give card 100 a three-dimensional appearance, but the color will have a metallic appearance due to the printing of color ink directly onto base substrate 102. Additional passes of Clear, White or CMYK can be added to create more complex visual effects.

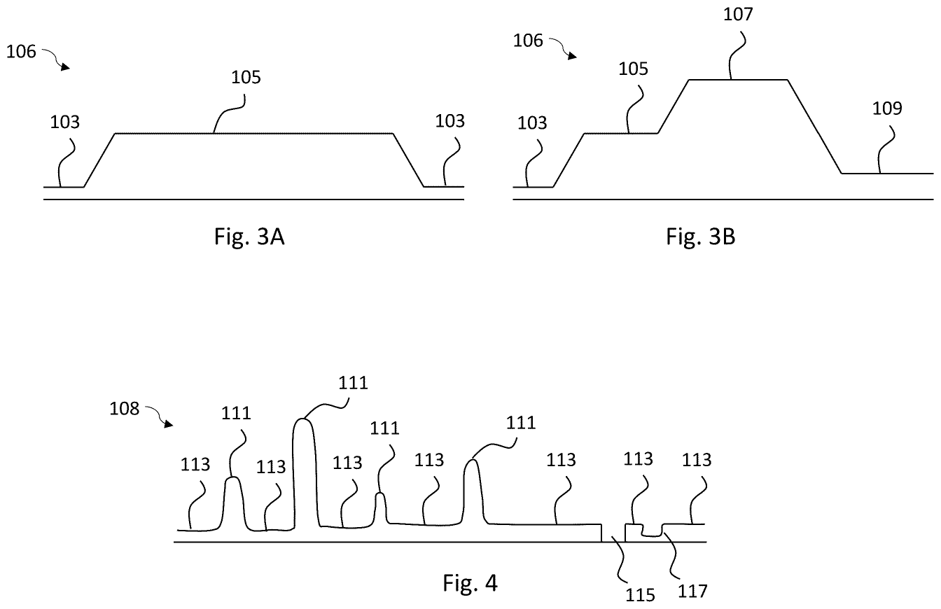

Referring now to FIGS. 3A and 3B, two different exemplary section views of UV ink layer 106 having different thickness at different points of the printing process are shown. These two views are merely intended to provide an illustrative overview of the different printing settings that may be possible with UV ink layer 106 and is not intended to be limiting.

Starting with FIG. 3A, UV ink layer 106 is printed at a first thickness 103 prior to being printed at a second thickness 105. However, depending on the print settings second thickness 105 may not be required for the entire printing of UV ink layer 106 and the layer can be printed again at first thickness 103. As shown in FIG. 3B, multiple different thickness settings for UV ink layer 106 can be configured. UV ink layer can be printed at a first thickness 103, a second thickness 105, a third thickness 107, and finally a fourth thickness 109.

To determine what thickness UV ink layer 106 needs to be printed at, an image is first uploaded and a grayscale layer is applied that corresponds with the desired thickness for different locations of the image. The darker portions of the grayscale layer correspond with the thickness for UV ink layer 106. So, the darkest portion of the grayscale layer coincide with the thickest portion of UV ink layer 106, while alternatively, the lightest portion of the grayscale layer coincide with the thinnest portion of UV ink layer 106.

Referring now to FIGS. 4, a section view of UV layer 108 is shown to illustrate the different texture effects that are possible with the printing process of the present invention. This view is merely intended to provide an illustrative overview of the different printing settings that may be possible with UV ink layer 108 and is not intended to be limiting.

FIG. 4 shows multiple different peaks 111 that are printed at different heights relative to base 113 to provide a desired textured effect for UV ink layer 108. The height and width of peaks 111 can be varied depending on the textured effect that is desired. There are also additional printing techniques that can be used to provide different textured effects when desired such as printing inverted peak 117, or by not printing UV ink layer 108 at all in some areas, as illustrated by gap 115. To set the different heights of peaks 111, another greyscale layer is applied to an image so that different textured effects are applied at the intended location. The darker portions of the grayscale layer coincide with the height and location of peaks 111 and the lighter portions coincide with locations where minimal to no texture is required.

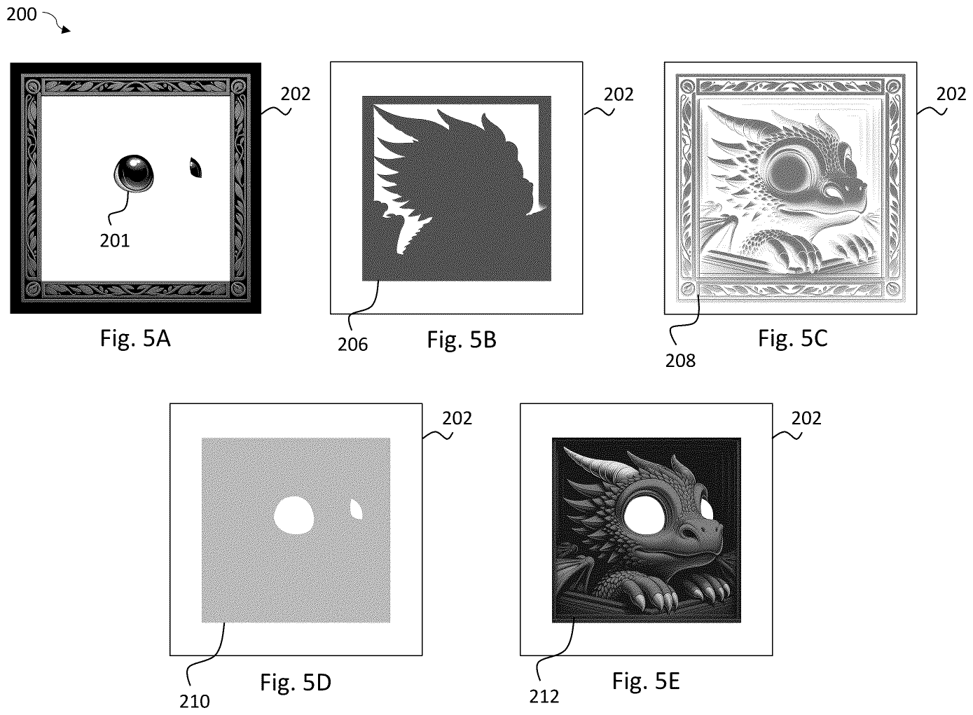

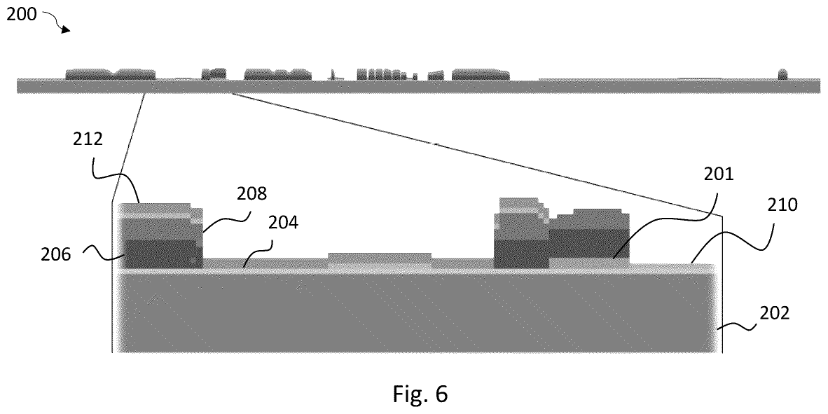

Referring now to FIGS. 5A-5E, different stages of an alternative printing process of the present invention onto card 200 is shown. In this alternative process a clear primer layer 204 (shown in FIG. 6) is still applied directly onto base substrate 202, however, a first color layer 201 may then be applied to certain areas of card 200 as shown in FIG. 5A. First color layer 201 is shown in FIG. 5A by the two eyes and decorative border and were printed first so that the properties of base substrate 202 directly impacted the appearance of the first color layer 201. In FIGS. 5B and 5C, the requisite thickness and texture layers are then printed directly onto card 200 with the application of UV ink layer 206 and UV ink layer 208 respectively. FIGS. 5D and 5E then show the final the final two layers, white ink 210 and second color layer 212, being printed onto card 200.

Referring now to FIG. 6, a section view of an alternative printing process of card 200 of the present invention is shown. These different layers follow the same printing process that was shown and discussed in detail for FIG. 2 with the exception of a first color layer 201 being printed directly onto clear primer 204.

While there have been shown what are presently considered to be preferred embodiments of the present invention, it will be apparent to those skilled in the art that various changes and modifications can be made herein without departing from the scope and spirit of the invention.

1. A three-dimensional card for printing an image or text comprising:
a base;
a priming layer applied to the base;
at least one layer of a first UV ink applied to the priming layer;
at least one layer of a second UV ink applied to the at least one layer of the first UV ink; and
a color layer applied to the at least one layer of the second UV ink.

2. The three-dimensional card for printing an image or text of claim 1, wherein the base is made out of aluminum.

3. The three-dimensional card for printing an image or text of claim 2, wherein the at least one layer of the first UV ink provides a thickness to the base.

4. The three-dimensional card for printing an image or text of claim 3, wherein the at least one layer of the second UV ink provides a texture to the base.

5. The three-dimensional card for printing an image or text of claim 4, wherein the second UV ink is a clear UV ink.

6. The three-dimensional card for printing an image or text of claim 5, further comprising a layer of white ink that is applied to the at least one layer of the second UV ink to improve the appearance of the color layer.

7. The three-dimensional card for printing an image or text of claim 6, wherein the layer of white ink is printed within a border of the image or the text that is to be printed onto the three-dimensional card.

8. The three-dimensional card for printing an image or text of claim 7, wherein the color layer applied to the at least one layer of the second UV ink is applied using a cyan, magenta, yellow, and black printing process.

9. The three-dimensional card for printing an image or text of claim 8, wherein the priming layer can be applied by being sprayed directly onto the substrate.

10. The three-dimensional card displaying an image or text of claim 8, wherein the priming layer can be applied with a Mayer bar coater.

11. A three-dimensional card for printing an image or text comprising;
a base substrate having a priming layer applied to improve the surface tension of the base substrate;
at least one layer of a first UV ink providing a thickness to the base substrate;
at least one layer of a second UV ink providing a texture to the base substrate;
a layer of white ink that is applied to at least one predetermined location on the at least one layer of the second UV ink; and
a layer of color ink that is applied to the layer of white ink and the at least one layer of the second UV ink.

12. The three-dimensional card for printing an image or text of claim 11, wherein the base substrate is made out of aluminum.

13. The three-dimensional card for printing an image or text of claim 12, wherein the second UV ink is a clear UV ink.

14. The three-dimensional card for printing an image or text of claim 13, wherein the layer of white ink is printed within a border of the image or the text that is to be printed onto the three-dimensional card.

15. The three-dimensional card for printing an image or text of claim 14, wherein the color layer applied to the at least one layer of the second UV ink is applied using a cyan, magenta, yellow, and black printing process.

16. The three-dimensional card for printing an image or text of claim 15, wherein the priming layer can be applied by being sprayed directly onto the substrate.

17. The three-dimensional card for printing an image or text of claim 15, wherein the priming layer can be applied with a Mayer bar coater.
